(19) United States
(12) Patent Application Publication
(10) Pub. No.: US 2014/0281361 A1
(43) Pub. Date: Sep. 18, 2014

(54) NONVOLATILE MEMORY DEVICE AND RELATED DEDUPLICATION METHOD

(71) Applicant: SAMSUNG ELECTRONICS CO., LTD., SUWON-SI (KR)

(72) Inventors: HYUNCHUL PARK, ANSAN-SI (KR); SANGMOK KIM, SEOUL (KR); OTAE BAE, DONG-GU (KR); KYUNG HO KIM, SEOUL (KR); JIN SEOK KIM, SEOUL (KR); SEUNGUK SHIN, SEOUL (KR)

(73) Assignee: SAMSUNG ELECTRONICS CO., LTD., SUWON-SI (KR)

(21) Appl. No.: 14/202,084

(22) Filed: Mar. 10, 2014

(30) Foreign Application Priority Data
Mar. 15, 2013 (KR) 10-2013-0028046

(51) Int. Cl. G06F 3/06; G06F 12/10

(52) U.S. Cl. CPC G06F 3/0641; G06F 12/10; G06F 3/0604; G06F 3/0679
USPC 711/206

(57) ABSTRACT

A nonvolatile memory device comprises an interface configured to receive write data and a logical address of the write data, a data storage device comprising multiple physical blocks and configured to store an address mapping table array, and a controller configured to selectively load at least one address mapping table from the address mapping table array based on the logical address. The controller performs a deduplication operation for the write data by comparing the write data with data stored in a physical block having a physical address in the loaded address mapping table, to the exclusion of data stored in other physical blocks.

### CROSS-REFERENCE TO RELATED APPLICATIONS

This application claims priority under 35 U.S.C. §119 to Korean Patent Application No. 10-2013-0028046 filed Mar. 15, 2013, the subject matter of which is hereby incorporated by reference.

### BACKGROUND OF THE INVENTION

The inventive concept relates generally to electronic memory technologies, and more particularly to nonvolatile memory devices and related deduplication methods.

The demand for information storage has increased dramatically throughout the information age. As this demand has continued to increase, researchers have developed several different types of storage devices that can be used in different devices and contexts.

Hard disk drives (HDDs) have been a popular form of storage device over the years because of attractive features such as high recoding density, high data transfer speed, fast data access time, low price, etc. A hard disk drive may be formed of a record type of disk where data is stored in a vacuous internal space, a head to read and write data on the disk, and an arm connected to the head. The disk may be a main data storage medium in which data is stored, and it may be formed of at least one or more aluminum plates. The aluminum plate may be referred to as a platter.

Recently, HDDs have been increasingly replaced with solid state drives (SSDs), which have an advantage over HDDs in that they generally include fewer mechanical components and are therefore less susceptible to mechanical defects. In addition, SSDs may have better access speed, smaller size, and other advantages. Nevertheless, SSD may still be inferior to HDDs in some regards, such as storage capacity and cost.

As SSDs continue to be adopted on a broader scale, there remains a general need to improve their performance characteristics, as well as those of their underlying storage components.

### SUMMARY OF THE INVENTION

In one embodiment of the inventive concept, a nonvolatile memory device comprises an interface configured to receive write data and a logical address of the write data, a data storage device comprising multiple physical blocks and configured to store an address mapping table array, and a controller configured to selectively load at least one address mapping table from the address mapping table array based on the logical address. The controller performs a deduplication operation for the write data by comparing the write data with data stored in a physical block having a physical address in the loaded address mapping table, to the exclusion of data stored in other physical blocks.

In another embodiment of the inventive concept, a nonvolatile memory device comprises an interface configured to receive write data and a logical address of the write data, a data storage device comprising multiple physical blocks and configured to store a zone context array formed of multiple zone contexts, and a controller configured to selectively load at least one zone context from the zone context array based on the logical address. The zone context comprises an address mapping table comprising mapping information between logical addresses and physical addresses and a hash mapping table comprising mapping information between hash values and physical addresses. The controller calculates a hash value of the write data. The controller performs a deduplication operation for the write data based on a hash value in the loaded hash mapping table and the calculated hash value.

In yet another embodiment of the inventive concept, a method of deduplicating a nonvolatile memory device comprises receiving write data and a logical address of the write data, selectively loading, into a controller, at least one address mapping table from an address mapping table array based on the logical address, and comparing, in the controller, the write data with data stored in a physical block having a physical address in the loaded address mapping table, to the exclusion of data stored in other physical blocks of the nonvolatile memory device.

These and other embodiments of the inventive concept can potentially improve deduplication performance by reducing the required number of operations without significantly reducing accuracy.

### BRIEF DESCRIPTION OF THE DRAWINGS

The drawings illustrate selected embodiments of the inventive concept. In the drawings, like reference numbers indicate like features.

FIG. 1 is a block diagram illustrating a nonvolatile memory device and host, according to an embodiment of the inventive concept.

FIG. 2 is a diagram illustrating zones and address mapping tables corresponding to the zones, according to an embodiment of the inventive concept.

FIG. 3 is a block diagram illustrating a controller shown in FIG. 1, according to an embodiment of the inventive concept.

FIG. 4 is a flowchart illustrating a deduplication operation of a nonvolatile memory device according to an embodiment of the inventive concept.

FIG. 5 is a graph illustrating input/output traces and a data redundancy ratio measured with respect to a zone therein, according to an embodiment of the inventive concept.

FIG. 6 is a flowchart a deduplication operation, according to another embodiment of the inventive concept.

FIG. 7 is a block diagram illustrating a controller, according to another embodiment of the inventive concept.

FIG. 8 is a flowchart illustrating a deduplication operation on a zone of FIG. 6, according to an embodiment of the inventive concept.

FIG. 9 is a flowchart illustrating a deduplication operation, according to still another embodiment of the inventive concept.

FIG. 10 is a block diagram illustrating a SSD system comprising a nonvolatile memory device, according to an embodiment of the inventive concept.

FIG. 11 is a block diagram illustrating a memory card comprising a nonvolatile memory device, according to an embodiment of the inventive concept.

FIG. 12 is a diagram illustrating various systems that can be used in combination with a memory card of FIG. 11, according to various embodiments of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “first”, “second”, “third”, etc., may be used to describe various features, but the described features should not be limited by these terms. Rather, these terms used merely to distinguish between different features. Thus, a first feature could be termed a second feature without materially altering the meaning of the relevant description.

Spatially relative terms, such as “beneath”, “below”, “lower”, “under”, “above”, “upper” and the like, may be used herein for ease of description to describe spatial relationships of features as shown in the drawings. The spatially relative terms are intended to encompass different orientations of the illustrated embodiments in use or operation, in addition to those shown. For example, if the device in the drawings were turned over, features described as “below” or “beneath” or “under” other features would then be oriented “above” the other features. Thus, the terms “below” and “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to limit the inventive concept. As used herein, the singular forms “a”, “an” and “the” are intended to include the plural forms as well, unless the context clearly indicates otherwise. Terms such as “comprises” and/or “comprising,” where used in this specification, indicate the presence of stated features but do not preclude the presence or addition of other features. As used herein, the term “and/or” indicates any and all combinations of one or more of the associated listed items.

Where a feature is referred to as being “on” or “connected to” another feature, it can be directly on or connected to the other feature or intervening features may be present. In contrast, where a feature is referred to as being “directly on” or “directly connected to” another feature, there are no intervening features present.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present specification and should not be interpreted in an idealized or overly formal sense unless expressly so defined herein.

FIG. 1 is a block diagram illustrating a nonvolatile memory device 100 and host 101, according to an embodiment of the inventive concept.

Host 101 controls a nonvolatile memory device 100. Host 101 may be implemented by an electronic device such as a PMP, a PDA, a handheld electronic device (e.g., a smart phone), a computer or a HDTV. Nonvolatile memory device 100 stores data under control of host 101. Data stored in nonvolatile memory device 100 may be retained even in the absence of applied power. Nonvolatile memory device 100 may be an SSD, although the inventive concept is not limited thereto.

Nonvolatile memory device 100 performs a deduplication operation on write data input from host 101. The deduplication operation compares the write data with current data nonvolatile memory device 100 to avoid storing redundant copies of the same data. With the deduplication operation, the write data may not be stored in nonvolatile memory device 100. For example, when data input from host 101 is the same as previously stored data, nonvolatile memory device 100 may map a logical block address of the write data onto a physical block address of the previously stored data, without storing the write data.

In some embodiments, nonvolatile memory device 100 determines a range of data to be reviewed in the deduplication operation, based on a logical block address of the write data. This range is typically determined by a logical block address of the write data. By limiting the range of data to be reviewed, nonvolatile memory device 100 may reduce the time and number of operations required to perform the deduplication operation. Moreover, if the probability of identifying any redundant data within the limited range is relatively high compared to a remainder of nonvolatile memory device, the use of the limited range may have fairly high accuracy as well.

Referring to FIG. 1, nonvolatile memory device 100 comprises a data storage device 110 and a controller 120.

Data storage device 110 stores data under control of controller 120. Multiple channels CH1 to CHn are provided between data storage device 110 and controller 120. Each of channels CH1 to CHn may be connected to multiple nonvolatile memories.

In some embodiments, data storage device 110 comprises a flash memory, although the inventive concept is not limited thereto. For example, data storage device 110 may comprise nonvolatile memories such as a MRAM, a PRAM, etc. Also, where data storage device 110 comprises a flash memory, a type of flash memory cell and a data storage characteristic may be variously changed or modified.

Controller 120 controls data read and write operations of data storage device 110 in response to a command provided from host 101. Controller 120 performs a deduplication operation on write data based on a logical block address of the write data provided from host 101.

In some embodiments, controller 120 identifies a zone of input data based on a logical block address of the input data. The zone may be a set of logical block addresses using an address mapping table. Controller 120 performs the deduplication operation based on the distinguished zone, as will be more fully described with reference to FIG. 2.

FIG. 2 is a diagram illustrating zones and address mapping tables corresponding to the zones, according to an embodiment of the inventive concept.

A logical block address of data provided from a host 101 may refer to any location of a logical memory space that software driven on host 101 recognizes. Thus, a logical block address may not coincide with a physical memory space of a data storage device 110.

Controller 120 converts a logical block address of data provided from host 101 into a physical block address PBA of data storage device 110 to process the data provided from host 101. Where a main memory in controller 120 is smaller than a predetermined size, the whole mapping information between logical block addresses and physical block addresses may not be loaded onto controller 120 at a time. To load address mapping information onto controller 120 having a less size of main memory, the whole address mapping information may be partitioned by a specific size unit. Partitioned mapping information may constitute an address mapping table.

Referring to FIG. 2, logical block addresses LBA used by host 101 may be divided into k zones each having a specific size. Logical block addresses assigned to each zone and physical block addresses PBA1 to PBAk corresponding to the logical block addresses form address mapping tables MT1 to MTk, respectively.

Mapping information for logical block addresses forms an address mapping table array [MT1:MTk]. Address mapping table array [MT1:MTk] is stored in data storage device 110. Controller 120 loads and uses an address mapping table corresponding to a logical block address of write data to be currently processed, from among the address mapping tables of address mapping table array [MT1:MTk].

Referring again to FIG. 1, controller 120 determines a zone that corresponds to a logical block address of the received write data. If controller 120 does not currently store an address mapping table for the determined zone, such an address mapping table may be loaded to controller 120 from data storage device 110.

Controller 120 performs a deduplication operation for the write data by a zone unit. In other words, it performs a deduplication operation by comparing the write data with data using the same address mapping table. Stated yet another way, controller 120 performs a deduplication operation by comparing the write data to data stored in physical blocks having physical block addresses mapped onto logical block addresses belonging to the same zone as the write data, rather than all data stored in data storage device 110.

FIG. 3 is a block diagram illustrating an example of controller 120 of FIG. 1, according to an embodiment of the inventive concept.

Referring to FIG. 3, controller 120 comprises a host interface 121, a memory interface 122, a processing unit 123, and a main memory 124.

Host interface 121 provides an interface between a host 101 and controller 120. Data exchange between host 101 and controller 120 is typically performed through one or more of various standardized interfaces, such as Advanced Technology Attachment (ATA), Serial ATA (SATA), External SATA (e-SATA), Small Computer Small Interface (SCSI), Serial Attached SCSI (SAS), Peripheral Component Interconnection (PCI), PCI Express (PCI-E), Universal Flash Storage (UFS), Universal Serial Bus (USB), IEEE 1394, and Card interfaces.

Memory interface 122 provides an interface between data storage device 110 and controller 120. For example, data processed by processing unit 123 may be stored in data storage device 110 through memory interface 122. Data stored in data storage device 110 may be provided to processing unit 123 through memory interface 122. Processing unit 123 controls overall operations of controller 120. Processing unit 123 comprises a central processing unit (CPU) or a microprocessor unit (MPU). Processing unit 123 drives firmware for controlling controller 120. The firmware may be loaded and driven onto main memory 124.

Main memory 124 stores firmware for controlling controller 120 and data. The firmware and data stored in main memory 124 may be driven by processing unit 123. Main memory 124 stores metadata or cache data. Main memory 124 may be formed of a cache memory, a DRAM, an SRAM, a PRAM, etc. A deduplication manager 124a and an address mapping table 124b are loaded onto main memory 124. Main memory 124 loads deduplication manager 124a and address mapping table 124b from data storage device 110 under control of processing unit 123.

Address mapping table 124b is a table storing mapping information between a logical block address of a zone comprising data provided from host 101 and a physical block address. Multiple address mapping tables may be loaded onto main memory 124.

In a write operation, write data to be written and a logical block address of the write data is provided from host 101. Deduplication manager 124a determines a zone comprising a logical block address of data provided from host 101. Where an address mapping table, corresponding to the determined zone, is not found among address mapping tables currently loaded on main memory 124, processing unit 123 loads the address mapping table of the determined zone onto main memory 124 from data storage device 110.

Deduplication manager 124a compares data provided from host 101 with data stored in physical blocks to be reviewed, based on the loaded address mapping table 124b. Physical blocks that deduplication manager 124a refers to may be physical blocks having a physical block address corresponding to a logical block address belonging to the same zone as that of the data provided from host 101.

Where the same data is searched, deduplication manager 124a does not store data provided from host 101 in data storage device 110. Instead, deduplication manager 124a updates address mapping table 124b such that a logical block address of data provided from host 101 is mapped onto a physical block address of a physical block in which the same data searched is stored. On the other hand, if the same data is not searched, deduplication manager 124a stores data provided from host 101 in data storage device 110, and updates address mapping table 124b.

FIG. 4 is a flowchart illustrating a deduplication operation of a nonvolatile memory device according to an embodiment of the inventive concept.

Referring to FIG. 4, in step S110, a write request is provided from a host 101. Host 101 provides write data and a logical block address of the data to a nonvolatile memory device 100. In step S120, a zone to which the logical block address of the write data belongs is determined based on the logical block address of the data.

In step S130, whether an address mapping table of the determined zone is loaded in main memory 124 of controller 120 is determined. If the address mapping table of the determined zone is not stored in main memory 124, in step S135, controller 120 loads an address mapping table of the determined zone stored in a data storage device 110 onto main memory 124.

In step S140, a deduplication operation is performed with respect to the write data. This operation comprises comparing the write data with data stored in a physical block corresponding to a logical block address of the same zone as that of the write data.

If the same data is searched, the write data may not be stored in data storage device 110. Instead, a logical block address of the write data may be mapped onto a physical block address of a physical block in which the same data searched is stored. On the other hand, if the same data is not searched, the write data may be stored in data storage device 110, and a logical block address of the write data may be mapped onto a physical block address of a physical block in which data is stored.

Because a deduplication operation is performed by a zone unit, operations for deduplication may be reduced as compared to a manner in which a deduplication operation is performed based on all data stored in data storage device 110.

FIG. 5 is a graph illustrating input/output traces and a data redundancy ratio measured with respect to a zone therein, according to an embodiment of the inventive concept. In FIG. 5, a horizontal axis indicates an input/output trace and a zone therein, and a vertical axis indicates a data redundancy ratio. The graph of FIG. 5 is an example, and it shows generation of duplicated data collected in connection with a boot trace, an idle trace, an install trace, and an uninstall trace collected from the Android platform. Each trace may be divided into multiple zones. Each of gradations of the horizontal axis may indicate a zone. In FIG. 5, a trace A indicates a duplicated data ratio in each zone, and a trace B indicates a duplicated data ratio about the whole address space.

Referring to FIG. 5, a duplicated data ratio is variable according to each trace and a zone therein. Thus, where a zone is determined to be a zone in which duplicated data is scarcely generated, a deduplication operation for the zone may be omitted. Where a zone is determined to be a zone in which duplicated data is frequently generated, a deduplication operation for the zone may be selectively performed. Thus, it is possible to improve efficiency of the deduplication operation.

FIG. 6 is a flowchart a deduplication operation according to another embodiment of the inventive concept. In the deduplication operation of FIG. 6, a nonvolatile memory device performs a deduplication operation selectively based on a zone of write data.

Referring to FIG. 6, in step S210, a write request may be provided from a host 101. Host 101 provides data write requested and a logical block address of the data to nonvolatile memory device 100. In step S220, a zone that the logical block address of the data belongs to is determined based on the logical block address of the data.

In step S230, whether an address mapping table of the determined zone is loaded on main memory 124 of a controller 120 is determined. If an address mapping table of the determined zone does is not loaded in main memory 124, in step S235, controller 120 loads an address mapping table of the determined zone stored in a data storage device 110 onto main memory 124.

In step S240, whether a deduplication mode of the determined zone is activated is determined. The deduplication mode of the determined zone may be activated in response to a duplicated data ratio about data in a zone.

Duplicated data ratio information of each zone may be stored in data storage device 110 together with an address mapping table of the zone, and may be loaded onto the main memory. Or, duplicated data ratio information of each zone may be stored in a predetermined area of data storage device 110, and may be loaded independently from an address mapping table.

Where a deduplication mode of the determined zone is determined not to be activated, in step S245, a deduplication operation is not performed. The write data is stored in data storage device 110, and a logical block address of the write data may be mapped onto a physical block address of a physical block in which data is stored.

Where a deduplication mode of the determined zone is determined to be activated, in step S250, a deduplication operation for the write data associated with the determined zone is performed. The write data is compared with data stored in a physical block corresponding to a logical block address belonging to the same zone as that of the data.

If the same data is searched, the write data is not stored in data storage device 110. Instead, a logical block address of the write data may be mapped onto a physical block address of a physical block in which the same data searched is stored. On the other hand, if the same data is not searched, the write data is stored in data storage device 110, and a logical block address of the write data is mapped onto a physical block address of a physical block in which data is stored.

As an alternative to comparing write data with reference data, nonvolatile memory device 100 may use a hash value to perform a deduplication operation. That is, nonvolatile memory device 100 may compare a hash value calculated using write data with a hash value calculated using reference data instead of performing a comparison operation for all data.

FIG. 7 is a block diagram illustrating a controller, according to another embodiment of the inventive concept.

Referring to FIG. 7, a controller 220 comprises a host interface 221, a memory interface 222, a processing unit 223, and a main memory 224. Host interface 221 and memory interface 222 may be substantially the same as those of FIG. 3, so a description thereof is omitted for the sake of brevity.

Processing unit 223 controls operations of controller 220. Processing unit 223 drives firmware for controlling controller 220. The firmware may be loaded and driven onto main memory 224.

Main memory 224 stores firmware for controlling controller 220 and data. A deduplication manager 224a, an address mapping table 224b, and a hash mapping table 224c may be loaded onto main memory 224. Main memory 224 loads deduplication manager 224a, address mapping table 224b, and hash mapping table 224c from a data storage device 110 under control of processing unit 223.

Address mapping table 224b stores mapping information between logical block addresses of zones and physical block addresses corresponding to the logical block addresses. Hash mapping table 224c stores a hash value and a physical block address of a physical block in which data having the hash value is stored.

Address mapping table 224b and hash mapping table 224c for one zone constitute a zone context. Multiple zone contexts may be loaded onto main memory 224.

In a write operation, write data and a logical block address of the write data are provided from host 101. Deduplication manager 224a determines a zone in which a logical block address of data provided from host 101 is included.

If a zone context corresponding to the determined zone is not found among zone contexts currently loaded on main memory 224, processing unit 223 loads a zone context of the determined zone stored in data storage device 110 onto main memory 224.

Deduplication manager 224a calculates a hash value of data provided from host 101 using a hash function. Deduplication manager 224a determines whether data having the same hash value as the calculated hash value is stored in physical blocks having a physical block address corresponding to the zone.

In some embodiments, hash values of entries of hash mapping table 224c are fixed. Because hash mapping table 224c having fixed hash values is used, hash values need not be stored separately. If hash mapping table 224c having fixed hash values is used, a bit number of a hash value for comparing data may be decided according to the size of hash mapping table 224c. Where hash mapping table 224c having a size smaller than a predetermined size is used, a bit number of a hash value for comparing data may be reduced. In this case, a collision may be generated. The term of “collision” here indicates such a state that different data has the same hash value. Where a bit number of a hash value for comparing data increases, the probability that a collision is generated may be low. However, the size of hash mapping table 224c may increase. Deduplication manager 224a according to an embodiment of the inventive concept may perform an operation of processing such a case that a collision is generated, to use a small size of hash mapping table 224c.

Deduplication manager 224a determines whether a calculated hash value exists in hash mapping table 224c. This operation may be performed to check whether data having the same hash value as the calculated hash value is stored in physical blocks having a physical block address corresponding to a zone.

Where the calculated hash value does not exist in hash mapping table 224c, deduplication manager 224a may store write data in data storage device 110, and may update address mapping table 224b and hash mapping table 224c.

When the calculated hash value exists in hash mapping table 224c, deduplication manager 224a may load data stored in data storage device 110 referring to a mapped physical block address. Deduplication manager 224a may compare the loaded data and the write data to check identity.

If the loaded data is equal to the write data, deduplication manager 224a may not store the write data in data storage device 110. Instead, deduplication manager 224a may update address mapping table 224b such that a logical block address of the write data is mapped onto a physical block address of a physical block in which the loaded data is stored.

If the loaded data is different from the write data, deduplication manager 224a may determine that a collision is generated. Deduplication manager 224a may perform various operations for processing such a case that a collision is generated.

In some embodiments, deduplication manager 224a stores the write data in data storage device 110, and it updates hash mapping table 224c such that there is added a physical block address of a physical block in which the write data is stored. Hash mapping table 224c may be implemented as a linked-list to store multiple physical block addresses.

In some other embodiments, deduplication manager 224a may be implemented such that earliest stored data in hash mapping table 224c monopolizes a hash value corresponding to the data. Deduplication manager 224a may store the write data in data storage device 110, while hash mapping table 224c may not be updated. Because hash mapping table 224c is maintained, a collision may be generated when a write operation about the same data as the write data is requested by a host 101.

In some other embodiments, deduplication manager 224a may update hash mapping table 224c in response to the number of collisions. Deduplication manager 224a may count the number of collisions about each entry.

Where the number of collision counted exceeds a predetermined threshold value, deduplication manager 224a may store the write data in data storage device 110, and it replaces a physical address mapped onto a hash value of hash mapping table 224c with a physical block address of a physical block in which the write data is stored. Where an entry of hash mapping table 224c is updated, deduplication manager 224a resets a count value about the updated entry. On the other hand, where the number of collision counted is lower than the predetermined threshold value, deduplication manager 224a stores the write data in data storage device 110, and it maintains hash mapping table 224c.

Deduplication manager 224a and nonvolatile memory device 100 comprising the same may use a hash mapping table to perform a deduplication operation by a zone unit. Also, nonvolatile memory device 100 may provide various algorithms for updating a hash mapping table and an address mapping table to process such a case that a collision is generated. Nonvolatile memory device 100 may perform a deduplication operation by a zone unit using a hash mapping table with a predetermined size. Thus, it is possible to perform a deduplication operation with relatively few calculations and small memory space.

FIG. 8 is a flowchart illustrating a deduplication operation on a zone of FIG. 6, according to an embodiment of the inventive concept.

Referring to FIG. 8, in step S251, a hash value of write data received from a host 101 is calculated. The hash value may be calculated using various hash functions. In step S252, whether the calculated hash value is already mapped onto a hash mapping table 225c is determined. Where the calculated hash value is already mapped onto hash mapping table 225c, in step S253, whether data stored in a physical block having a physical block address corresponding to the mapped hash value is equal to the write data is determined.

Where the calculated hash value is not mapped onto hash mapping table 225c or where data stored in a physical block having a physical block address corresponding to the mapped hash value is not equal to the write data, in step S254, the write data is stored in nonvolatile memory device 100.

In step S255, an address mapping table 224b and hash mapping table 224c about the write data is updated.

In step S252, where the calculated hash value is not mapped onto hash mapping table 224c, hash mapping table 224c may be updated such that a physical block address of a physical block in which data is stored is mapped onto the write data. Also, address mapping table 224b is updated such that a physical block address of a physical block in which data is stored is mapped onto a logical block address of the input data.

In step S253, if data stored in a physical block having a physical block address corresponding to the mapped hash value is not equal to the write data, address mapping table 224c is updated such that a physical block address of a physical block in which data is stored is mapped onto a logical block address of the write data. Also, hash mapping table 224c may be updated to process a collision. For example, hash mapping table 224c may be updated such that there is added a physical block address of a physical block in which write data is stored. Hash mapping table 224c may be implemented to have a linked-list form to store multiple physical block addresses.

In some other embodiments, hash mapping table 224c may be maintained without updating. Alternatively, hash mapping table 224c may be updated in response to the number of collisions about a hash value.

In step S254, where write data from host 101 is stored in nonvolatile memory device 100, address mapping table 224b may be updated such that a logical block address of the write data is mapped onto a physical block address of a physical block in which data is stored.

In step S253, where data stored in a physical block having a physical block address corresponding to the mapped hash value is equal to the write data, address mapping table 224b may be updated such that a logical block address of the input data is mapped onto a physical block address of a physical block in which previous data is stored. Hash mapping table 224c may be maintained without updating.

With a deduplication operation performed by a zone unit, a hash mapping table may be used to compare data. Also, there may be provided various algorithms for updating a hash mapping table and an address mapping table to process such a case that a collision is generated. Because a deduplication operation is performed by a zone unit using a hash mapping table with a predetermined size, it is possible to perform a deduplication operation with relatively few calculations and small memory space.

FIG. 9 is a flowchart illustrating a deduplication operation according to still another embodiment of the inventive concept. In the example of FIG. 9, a deduplication operation is performed based on the probability of finding duplicated data in the zone.

Referring to FIG. 9, in step S310, a write request is provided from host 101. Host 101 provides write and a logical block address of the write data to nonvolatile memory device 100.

In step S320, a zone a logical block address of the write data is determined based on the logical block address of the write data.

In step S330, whether a zone context of the determined zone, that is, an address mapping table 224b and a hash mapping table 224c are loaded on main memory 224 of controller 220 is determined. If a zone context of the determined zone does not exist in main memory 124, in step S335, controller 220 loads a zone context of the determined zone stored in a data storage device 110 onto main memory 224.

In step S340, a hash value of the write data is calculated. The hash value may be calculated using any of various alternative hash functions.

In step S350, whether the calculated hash value is already mapped onto a hash mapping table 225c is determined. Where the calculated hash value is already mapped onto hash mapping table 225c, in step S351, a hit rate of the determined zone increases. Where the calculated hash value is not mapped onto hash mapping table 225c, in step S352, a hit rate of the determined zone decreases.

The hit rate indicates the probability of finding duplicated data in each zone. The hit rate may be calculated using a rate of the number of events, indicating that a hash value on the number of accesses is mapped, to hash mapping table 224c.

In step S360, whether the hit rate of a zone exceeds a predetermined threshold value is determined. Where the hit rate of a zone exceeds the predetermined threshold value, in step S370, a deduplication mode of a zone is activated. Where the hit rate of a zone does not exceed the predetermined threshold value, in step S370, a deduplication mode of a zone is inactivated. In step S380, whether a deduplication mode of the determined zone is activated is determined. As understood from step S360, a deduplication mode of a zone may be activated in response to a duplicated data generation ratio to data in a zone.

Where a deduplication mode of the determined zone is not activated, a deduplication operation may be omitted. In step S385, the write data may be stored in data storage device 110, and a logical block address of the write data may be mapped onto a physical block address of a physical block in which data is stored.

Where a deduplication mode of the determined zone is activated, a deduplication operation about the write data may be performed with respect to the determined zone. The write data is compared with data stored in a physical block having a physical block address corresponding to a logical block address belonging to the same zone as that of the write data.

In the above-described deduplication operation, nonvolatile memory device 100 performs a deduplication operation selectively based on a hit rate of a zone of write data. Because nonvolatile memory device 100 performs the deduplication operation about data, the duplication probability of which is high, from among limited reference data, a deduplication operation may be efficiently performed.

FIG. 10 is a block diagram illustrating an SSD system comprising a nonvolatile memory device, according to an embodiment of the inventive concept.

Referring to FIG. 10, an SSD system 1000 comprises a host 1100 and an SSD 1200. Host 1100 comprises a host interface 1121, a host controller 1120, and a DRAM 1130.

Host 1100 reads and writes data in SSD 1200. Host controller 1120 transfers signals SGL such as a command, an address, a control signal, ID indicating a category of a file, etc. to SSD 1200 through host interface 1121. DRAM 1130 may be a main memory of host 1100.

SSD 1200 exchanges signals SGL with host 1100 through host interface 1211, and is supplied with a power through a power connector 1221. SSD 1200 comprises multiple nonvolatile memories 1201 to 120n, an SSD controller 1210, and an auxiliary power supply 1220. Herein, nonvolatile memories 1201 to 120n may be implemented by not only a NAND flash memory but also nonvolatile memories such as PRAM, MRAM, ReRAM, and so on.

Nonvolatile memories 1201 to 120n are used as a storage medium of SSD 1200. Nonvolatile memories 1201 to 120n are connected to SSD controller 1210 through multiple channels CH1 to CHn. One channel is connected to one or more nonvolatile memories. Nonvolatile memories connected to one channel are connected to the same data bus.

SSD controller 1210 exchanges signals SGL with host 1100 through host interface 1211. Herein, signals SGL comprises a command, an address, data, and the like. Also, signals SGL comprises ID indicating a category of a file. SSD controller 1210 is configured to write or read out data to or from a corresponding nonvolatile memory according to a command of host 1100.

Auxiliary power supply 1220 is connected to host 1100 through power connector 1221. Auxiliary power supply 1220 is charged by a power PWR from host 1100. Auxiliary power supply 1220 may be placed inside or outside SSD 1200. For example, auxiliary power supply 1220 may be put on a main board to supply an auxiliary power to SSD 1200.

SSD system 1000 performs a deduplication operation based on a logical block address of data input from a host 101. Because SSD system 1000 selectively performs the deduplication operation about data, the duplication probability of which is high, from among limited reference data, deduplication may be performed with relatively few calculations.

FIG. 11 is a block diagram illustrating a memory card 2000 comprising a nonvolatile memory device, according to an embodiment of the inventive concept. Memory card 2000 may be, for example, an MMC card, an SD card, a multiuse card, a micro-SD card, a memory stick, a compact SD card, an ID card, a PCMCIA card, an SSD card, a chip-card, a smartcard, an USB card, or the like.

Referring to FIG. 11, memory card 2000 comprises an interface circuit 2100 for interfacing with an external device, a controller 2200 comprising a buffer memory and controlling an operation of memory card 2000, and at least one nonvolatile memory device 2300. Controller 2200 typically comprises a processor that controls write and read operations of nonvolatile memory device 2300. Controller 2200 may be connected to nonvolatile memory device 2300 and interface circuit 2100 through a data bus and an address bus.

Controller 2200 performs a deduplication operation over a limited range of data based on a logical block address of write data received from host 101. As indicated above, performing the deduplication operation over a limited range of data can significantly improve performance without significantly reducing accuracy.

FIG. 12 is a diagram illustrating various systems that can be used in combination with memory card 2000 of FIG. 11, according to various embodiments of the inventive concept.

Referring to FIG. 12, memory card 2000 could be used with a video camera, a television, an audio device, a game machine, an electronic music device, a cellular phone, a computer, a Personal Digital Assistant, a voice recorder, and a PC card, in addition to various other systems.

The above described nonvolatile memory devices may be packaged using various types of packages such as Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The foregoing is illustrative of embodiments and is not to be construed as limiting thereof. Although a few embodiments have been described, those skilled in the art will readily appreciate that many modifications are possible in the embodiments without departing from the scope of the inventive concept as defined in the claims.

What is claimed is:

1. A nonvolatile memory device, comprising:
an interface configured to receive write data and a logical address of the write data;
a data storage device comprising multiple physical blocks and configured to store an address mapping table array; and
a controller configured to selectively load at least one address mapping table from the address mapping table array based on the logical address,
wherein the controller performs a deduplication operation for the write data by comparing the write data with data stored in a physical block having a physical address in the loaded address mapping table, to the exclusion of data stored in other physical blocks.

2. The nonvolatile memory device of claim 1, wherein the controller is further configured to load deduplication mode information from the data storage device based on the logical address and to selectively perform a deduplication operation based on the deduplication mode information.

3. The nonvolatile memory device of claim 1, wherein the controller comprises:
a main memory storing a deduplication manager and the at least one address mapping table; and
a processing unit configured to control the main memory such that the at least one address mapping table is selectively loaded from the address mapping table array and such that the deduplication manager performs a deduplication operation referring to data stored in a physical block having a physical address in the loaded address mapping table.

4. The nonvolatile memory device of claim 3, wherein the controller determines whether the write data is located among data stored in a physical block having a physical address in the loaded address mapping table, and controls the main memory to update the address mapping table according to the determination.

5. The nonvolatile memory device of claim 4, wherein where the write data is not located among data stored in a physical block having a physical address in the loaded address mapping table, the controller controls the data storage device such that the write data is stored in the data storage device.

6. The nonvolatile memory device of claim 4, wherein where the write requested is located among data stored in a physical block, having a physical address in the loaded address mapping table, the controller updates the address mapping table such that the logical address of the write data is mapped onto a physical address on the stored data.

7. A nonvolatile memory device, comprising:
an interface configured to receive write data and a logical address of the write data;
a data storage device comprising multiple physical blocks and configured to store a zone context array formed of multiple zone contexts; and
a controller configured to selectively load at least one zone context from the zone context array based on the logical address,
wherein the zone context comprises an address mapping table comprising mapping information between logical addresses and physical addresses and a hash mapping table comprising mapping information between hash values and physical addresses,
wherein the controller calculates a hash value of the write data, and
wherein the controller performs a deduplication operation for the write data based on a hash value in the loaded hash mapping table and the calculated hash value.

8. The nonvolatile memory device of claim 7, wherein where the calculated hash value has a matching hash value in the loaded hash mapping table, the controller compares data having a physical address mapped onto the matching hash value and the write data and updates the address mapping table and the hash mapping table based on the comparison result.

9. The nonvolatile memory device of claim 8, wherein when data having a physical address mapped onto the matching hash value is not equal to the write data, the controller controls the data storage device such that the write data is stored in a physical block of the data storage device.

10. The nonvolatile memory device of claim 9, wherein when data having a physical address mapped onto the matching hash value is not equal to the write data, the controller maps the matching hash value of the hash mapping table onto a physical address of a physical block in which the write data is stored.

11. The nonvolatile memory device of claim 10, wherein the hash mapping table comprises a linked-list.

12. The nonvolatile memory device of claim 9, wherein where data having a physical address mapped onto the matching hash value is not equal to the write data, the controller does not update the hash mapping table.

13. The nonvolatile memory device of claim 9, wherein the controller calculates a number of collisions on the matching hash value based on the comparison result, and
wherein when data having a physical address mapped onto the same hash value is not equal to the write data, the controller selectively updates the hash mapping table based on the number of collisions.

14. The nonvolatile memory device of claim 7, wherein the controller is further configured to load deduplication mode information from the data storage device based on the logical address and to selectively perform a deduplication operation based on the deduplication mode information.

15. The nonvolatile memory device of claim 14, wherein the controller updates the deduplication mode information based on the calculated hash value and a hash value in the loaded hash mapping table.

16. A method of deduplicating a nonvolatile memory device, comprising:
receiving write data and a logical address of the write data;
selectively loading, into a controller, at least one address mapping table from an address mapping table array based on the logical address; and
comparing, in the controller, the write data with data stored in a physical block having a physical address in the loaded address mapping table, to the exclusion of data stored in other physical blocks of the nonvolatile memory device.

17. The method of claim 16, further comprising loading deduplication mode information, into the controller, based on the logical address and selectively performing a deduplication operation based on the deduplication mode information.

18. The method of claim 16, wherein the controller comprises:
a main memory storing a deduplication manager and the at least one address mapping table; and
a processing unit configured to control the main memory such that the at least one address mapping table is selectively loaded from the address mapping table array and such that the deduplication manager performs a deduplication operation referring to data stored in a physical block having a physical address in the loaded address mapping table.

19. The method of claim 18, further comprising the controller determining whether the write data is located among data stored in a physical block having a physical address in the loaded address mapping table, and controlling the main memory to update the address mapping table according to the determination.

20. The method of claim 19, wherein where the write data is not located among data stored in a physical block having a physical address in the loaded address mapping table, the controller controls the data storage device such that the write data is stored in the data storage device.
